(19) United States
(12) Patent Application Publication
(10) Pub. No.: US 2005/0007364 A1
(43) Pub. Date: Jan. 13, 2005

(54) Method for sorting ununiformity of liquid crystal display panel sorting apparatus, and information recorded medium with recorded program for executing this sorting

(76) Inventors: Yoshifumi Oyama, Kumamoto (JP); Yoshinobu Ookuma, Kumamoto (JP)

Correspondence Address: MCGLEW & TUTTLE, PC, 1 SCARBOROUGH STATION PLAZA, SCARBOROUGH, NY, 10510-0827, US

(21) Appl. No.: 10/488,393

(22) PCT Filed: Aug. 27, 2002
(86) PCT No.: PCT/JP02/08597

(30) Foreign Application Priority Data
Aug. 27, 2001 (JP) 2001-256942

(51) Int. Cl. G06T 17/00

(52) U.S. Cl. 345/428

(57) ABSTRACT

The present invention relates to a process for classifying the panel MURA in the module inspection of a liquid crystal display panel.

The invention includes a MURA area logical operation process (S5) of photographing the liquid crystal display panel from different angles of visibility, performing an image processing for detecting a MURA area for a group of images taken and then performing an image logical operation process, an upper-level classification process (S6) of classifying the shape of MURA, and a lower-level classification process of classifying the panel MURA by combining an upper-level classification with other parameters. With this invention, the panel MURA is correctly detected without setting up the complicate parameters. This invention contributes to labor saving at the final inspection step for manufacturing and leads to quality assurance and higher reliability of the liquid crystal display panel in the liquid crystal display panel manufacturing field.

### TECHNICAL FIELD

The present invention relates to a classification process of panel MURA in a module inspection for a liquid crystal display panel, and more particularly to a MURA classification process making use of plural panel photograph images that are photographed from different angles of visibility.

### BACKGROUND ART

Automated MURA inspection for the liquid crystal display panel has been attempted in various parts of the industry. In this case, it is common practice that one sheet of image photographed from the front face of panel, namely, one sheet of image that may possibly have MURA is processed through the image processing techniques to detect any MURA present on the image. In this specification, the term imperfection that can be represented by blemish, blotch or unevenness is referred to as MURA, a transliterated Japanese word.

Also, to optimize the detection conditions of MURA, various kinds of parameters for detection had various thresholds different a little from each other to detect the area where MURA exists (hereinafter referred to as a MURA area). The problem with this method is a complicate process for detecting the MURA because there are various kinds of parameter settings and the fine setting of threshold values must be performed. Also, if the kind of product is changed, excess operations for changing the housekeeping may be needed. Therefore, the module inspection at final stage for the liquid crystal display panel is mainly performed in sensory evaluation through the eyes.

The conventional MURA inspection algorithms for the liquid crystal display panel involved, for example, calculating the sizes of MURA area and its peripheral area and the geometrical dimensions of MURA area through the arithmetical operation (Japanese Patent Laid-Open No. 10-96681), detecting defective pixels on the display panel by removing the interference fringe and the brightness MURA of the display panel, employing the difference information acquired from difference adding means (Japanese Patent Laid-Open No. 11-119684), and making two hierarchical inspections (macro inspection and micro inspection) (Japanese Patent Laid-Open No. 10-10007).

These conventional techniques involved detecting the MURA area from the image acquired in one direction. However, for the MURA dependent on the panel structure such as the angle of visibility (hereinafter referred to as a structural panel MURA), such as a gap MURA, in which the MURA area is complicate or difficult to discriminate from the front image but the brightness value is clearly changed by inclining the panel, it is theoritically difficult to detect and classify the panel MURA correctly using only one sheet of image.

### DISCLOSURE OF THE INVENTION

In this invention, detection of panel MURA is made by detecting a structural panel MURA without setting up the complicate parameters by employing not a single image in one direction, but a group of images photographed from different angles of visibility, whereby the panel MURA is efficiently classified according to the kind of defect caused by the structure.

The invention of claim 1 provides a method for classifying the kind of panel MURA on a liquid crystal display panel to detect the MURA caused by a structural defect arising on the surface of the liquid crystal display panel, in which a group of images for the liquid crystal display panel are photographed from different angles of visibility, and the feature of defective MURA is decided, using (i) a logical operation processing result between images obtained from the angle of visibility, (ii) and the feature amount obtained from the image. The used image data may be the brightness data having a property of dependency on the angle of visibility (hereinafter referred to as a visibility angle dependent brightness data).

The invention of claim 2 provides a device for classifying the MURA on the liquid crystal display panel at high speed in which the parallel processing steps according to the invention of claim 1 are constituted of a hardware such as a programmable gate array. Thereby, the module inspection for the liquid crystal display panel is made faster.

Moreover, the invention of claim 3 provides a program for enabling a computer to perform the steps according to the invention of claim 1. Such recording medium is dealt with independently of an information processing device employing it, and available on the market.

### BRIEF DESCRIPTION OF DRAWINGS

FIG. 1 is a view showing the typical MURA defects with their shapes appearing on the surface of a liquid crystal display panel surface;

FIG. 2 is a table showing the apparent features of typical MURA defects on the liquid crystal display panel;

FIG. 3 is a view exemplifying a group of images on the liquid crystal display panel photographed by an image sensor for use in this invention;

FIG. 4 is a flowchart showing an algorithm procedure for identifying the MURA;

FIG. 5 is a typical view showing a logical sum operation process and a logical product operation process in a MURA area logical operation process;

FIGS. 6A to 6C show the definition of parameters including brightness, elongation degree, and thickness for making the MURA upper-level classification as used in this invention, and a calculation method for making the upper-level classification;

FIG. 7 is a table showing an example of MURA classification identification process that is performed in this invention;

FIGS. 8A to 8C are views for explaining a spatial differential filter process;

FIGS. 9A to 9C are views for explaining a texture analysis process; and

FIG. 10 is a concept view showing a classification processing device for the liquid crystal display panel MURA of the invention.

### BEST MODE FOR CARRYING OUT THE INVENTION

The preferred embodiments of the present invention will be described below with reference to the accompanying drawings.

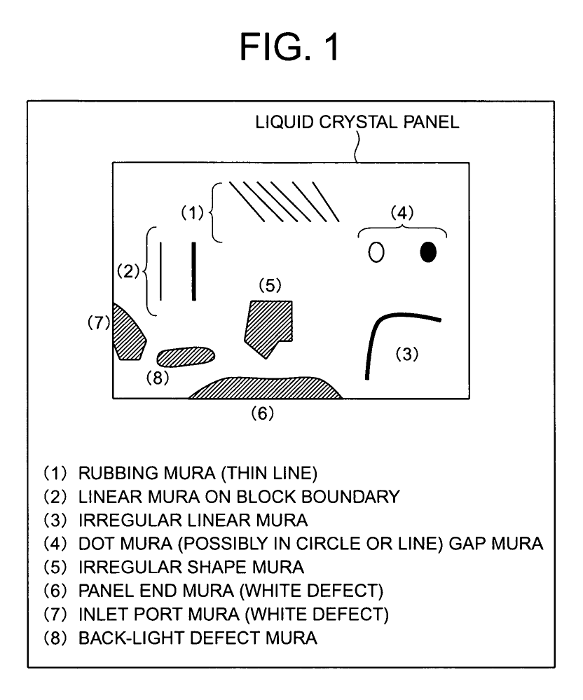

FIG. 1 is a view showing the typical panel MURA defects with their shapes appearing on the surface of a liquid crystal display panel surface. In FIG. 1, reference numeral (1) denotes a rubbing MURA appearing as plural thin lines, (2) denotes a linear MURA at the block boundary, (3) denotes an irregular linear MURA, (4) denotes a dot MURA and a gap MURA, (5) denotes an irregular shape MURA, (6) denotes a MURA arising at the panel end, (7) denotes a MURA arising at an inlet port, and (8) denotes a back-light defect MURA.

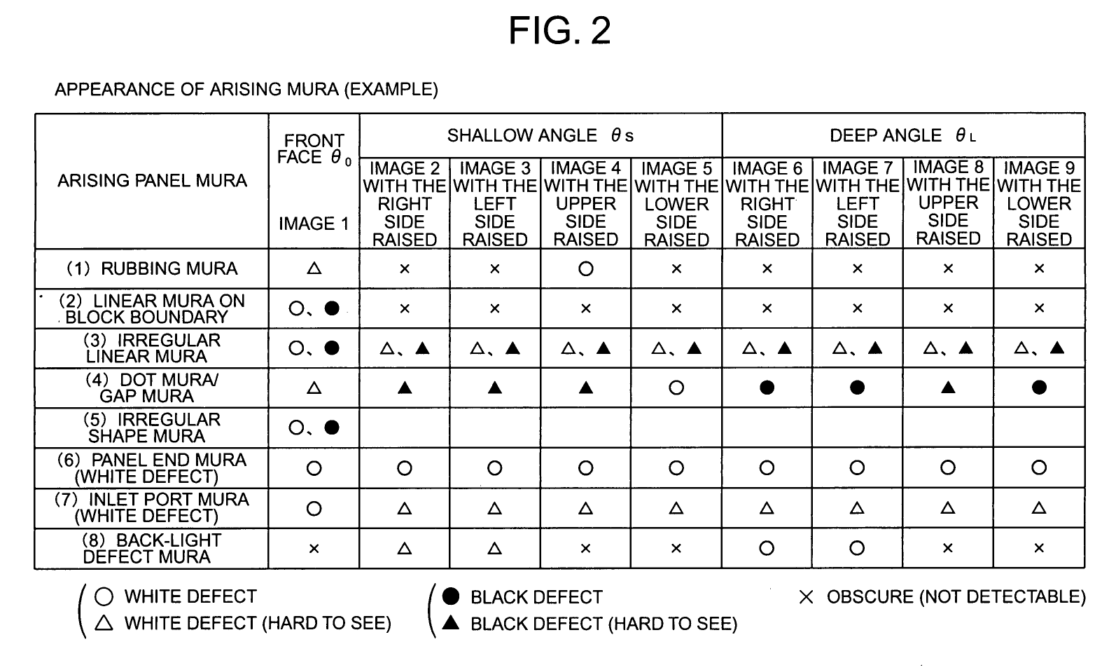

FIG. 2 is a table showing the apparent features of those typical MURA defects that look differently depending on the direction. The rubbing MURA (1) is difficult to see from the front face of the liquid crystal display panel, but easy to see if the upper side of the liquid crystal display panel is raised to the fore side by a shallow angle of about 5 to 10 degrees. The linear MURA at the block boundary (2) looks white or blackish from the front face and is easy to discriminate, but is difficult to see if the liquid crystal panel is inclined. The irregular linear MURA (3) looks white or blackish from the front face and is easy to discriminate, but difficult to discriminate at an inclined angle. The dot and gap MURA (4) often looks whitish from the front face, but often looks blackish at an inclined angle to the left or right, and often looks more whitish if the lower side is raised to the fore side by a shallow angle. The irregular shape MURA (5) looks white or blackish from the front face and is easy to discriminate.

MURA (6) in the liquid crystal display panel end looks whitish from the front face or at an inclined angle. The inlet port MURA (7) often looks whitish from the front face, and looks likewise at an inclined angle. The spot MURA (8) of white caused by back-light is difficult to discriminate from the front face, but clearly looks like white points at an inclined angle of more than about 30 degrees to the left or right.

In the liquid crystal display panel, since the transmitting light is changed in directivity by the fine thickness or waviness of a liquid crystal film, the detection precision of panel MURA is increased as seen from all the angles of upper, lower, left and right directions. This invention is characterized in that the group of images of the liquid crystal display panel photographed from various angles of visibility are combined to detect the panel MURA

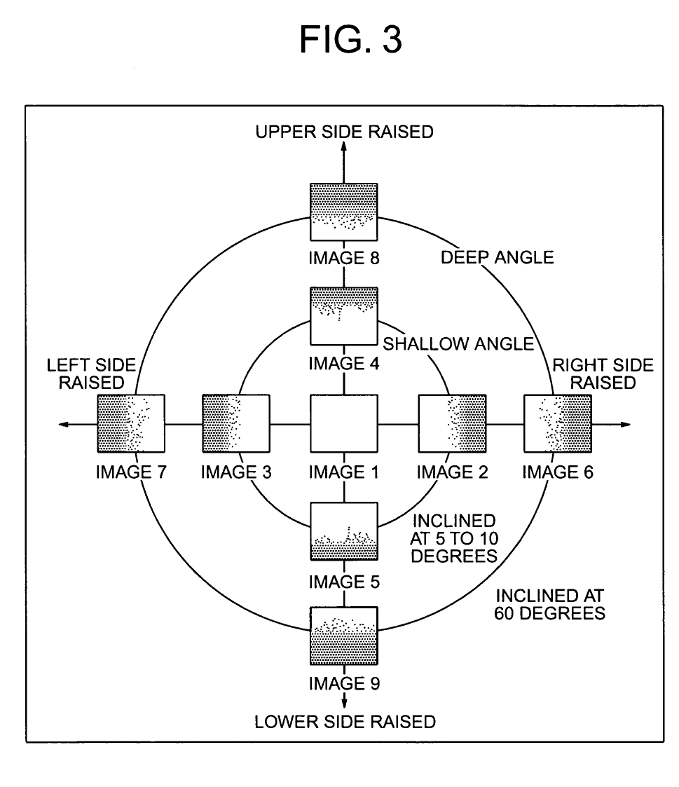

FIG. 3 is a view exemplifying a group of images on the liquid crystal display panel photographed by an image sensor (CCD sensor, linear sensor, area sensor, etc.) for use in this invention, in which the liquid crystal display panel is inclined at shallower or deeper angles in four directions of the upper, lower, left and right sides around the center of the liquid crystal display panel. An image 1 is a liquid crystal panel image photographed from the front face of the liquid crystal panel. An image 2 is a liquid crystal panel image photographed in a state where the right side of panel is raised at a shallow inclined angle, for example, 10 degrees. An image 6 is a liquid crystal panel image photographed in a state where the right side of panel is raised at a deep inclined angle, for example, 60 degrees. An image 3 is a liquid crystal panel image photographed in a state where the left side of panel is raised at a shallow inclined angle, for example, 10 degrees. An image 7 is a liquid crystal panel image photographed in a state where the left side of panel is raised at a deep inclined angle, for example, 60 degrees. An image 4 is a liquid crystal panel image photographed in a state where the upper side of panel is raised at a shallow inclined angle, for example, 10 degrees. An image 8 is a liquid crystal panel image photographed in a state where the upper side of panel is raised at a deep inclined angle, for example, 60 degrees. An image 5 is a liquid crystal panel image photographed in a state where the lower side of panel is raised at a shallow inclined angle, for example, 10 degrees. An image 9 is a liquid crystal panel image photographed in a state where the lower side of panel is raised at a deep inclined angle, for example, 60 degrees. The number of sheets and angle of photographed images for use are not limited to those of the group of images as shown in FIG. 3.

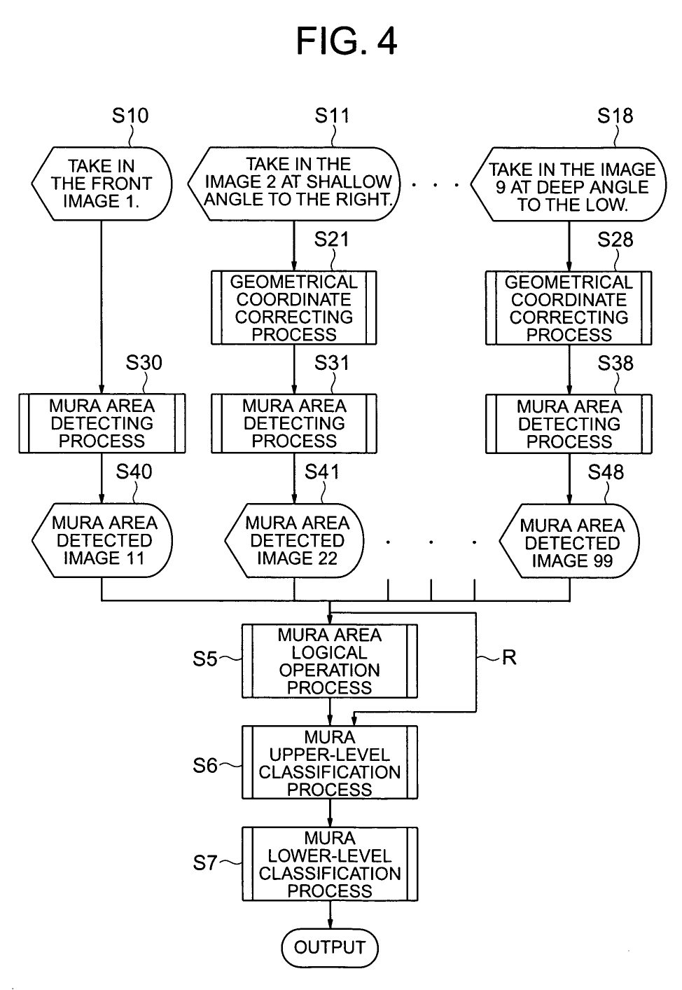

FIG. 4 is a flowchart showing an algorithm procedure for identifying the MURA according to the invention. This procedure will be explained using an example of nine images as shown in FIG. 3. The liquid crystal display panel is laid on a table. The liquid crystal display panel face is photographed by the image sensor (CCD sensor, line sensor, area sensor, etc.), when the table is not inclined (front face) firstly, and then inclined in a predetermined order at a predetermined angle (10 degrees or 60 degrees) in a predetermined direction (upper, lower, left or right) around the center of liquid crystal display panel as shown in FIG. 3. Thereby, plural photographed images 1 to 9 are taken in succession into the apparatus of the invention (steps S10, S11 to S18). In measuring the brightness distribution of this liquid crystal panel, data of image photographed at any angle may be employed as photographed image data.

The procedure of FIG. 4 involves performing a MURA area detecting process in parallel for each photographed image. The photographed images 1 to 9 are detected as the MURA area detected images 11 to 99 through the MURA area detecting process (steps S30 to S38) and displayed (steps S40 to S48). The photographed images 2 to 9 of the inclined panel is more distorted than the image 1 photographed from the front face, and have the distorted coordinates of the image. Therefore, it is required to correct plural images so that the coordinates of the image photographed at inclination may be matched with the coordinates of the image photographed from the front face to make corresponding pixels in plural images coincident (steps S1 to S28). The image photographed at inclination needs to later undergo the image processing of matching its geometrical coordinates with those of the front image. Therefore, a geometrical coordinate correcting process (steps S21 to S28) is performed before the MURA detecting process (steps S31 to S38).

In the MURA area detecting process at steps S30 to S38, the linear MURA and the facial MURA that is spread on the face are detected at high sensitivity, employing at least one of the texture analysis process and the spatial differential filter process that are well known as the image processing. The details of this MURA area detecting process will be described below.

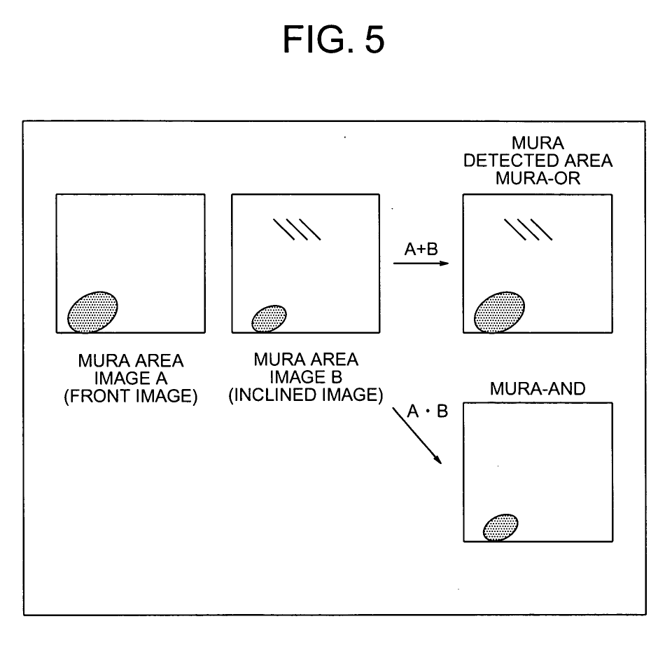

Using the MURA area detected images 11 to 88 obtained through the MURA area detecting process at steps S30 to S38, the MURA area logical operation process is performed (step S5). FIG. 5 is a typical view showing a logical sum operation process and a logical product operation process in the MURA area logical operation process. A detection area detected through the logical sum operation process is represented by MURA_OR, and a detection area detected through the logical product operation process is represented by MURA_AND.

Though the photographed image 1 from the front face had no MURA detected by performing the MURA area detecting process, MURA may exist on the image photographed at another angle of visibility. In this case, the MURA detected area detected in making the OR logic as a result of performing the MURA area logical operation process is MURA_OR. On the other hand, the MURA detected area detected in making the AND logic in the MURA area logical operation process for images at plural angles of visibility is MURA_AND.

These MURA area logical operation processes have a role of increasing the detection precision of panel MURA, and largely classifying the kinds of structural panel MURA (for simplicity, hereinafter abbreviated as a structural MURA) on the liquid crystal display panel according to the apparent features (see FIG. 2) as seen at various angles of visibility. It is necessary that a logical expression in the MURA area logical operation process can classify and identify the structural MURA by making the logical operation based on the feature of structural MURA appearing on the group of images. Of course, when the kind of structural MURA is fully determined only by the feature appearing on one image, the logical operation process may be omitted (path R as shown in FIG. 4).

Classification of the panel MURA is made for each of the extracted MURA detected areas MURA_OR and MURA_AND. As shown in the procedure of FIG. 4, first of all, the MURA upper-level classification process is performed (step S6), and then the MURA lower-level classification process is performed (step S7), whereby the MURA (structural panel MURA or structural MURA) that is the structural defect of the liquid crystal display panel is output for each kind.

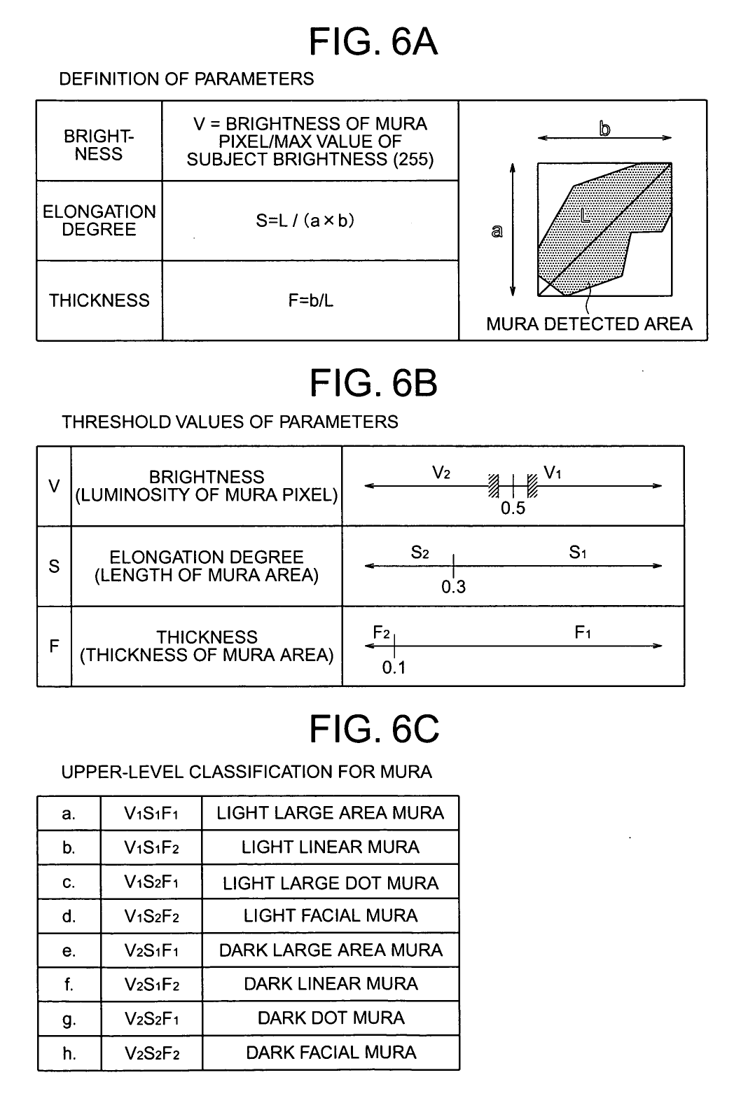

The MURA upper-level classification process at step S6 will be explained. FIGS. 6A to 6C show the definition of parameters including brightness, elongation degree, and thickness for making the MURA upper-level classification, and a calculation method for making the upper-level classification. A hatched area in FIG. 6A represents a MURA detected area that is either MURA_OR or MURA_AND obtained through the MURA area detecting process. The kinds of panel MURA are largely classified into eight, for example, according to the parameters obtained from the area image, representing the brightness and shape of MURA detected area. In the MURA upper-level classification process, the kinds of panel MURA are classified according to the brightness and shape, but not to the difference caused by the structure of the liquid crystal display panel.

More specifically, the parameters including the brightness V representing the subjective brightness of MURA area, the elongation degree S representing the length of MURA area and the thickness F representing the thickness of MURA area are extracted from the MURA area of the image subject to the MURA area logical operation, the MURA area being shown with hatching in FIG. 6A. As shown in FIG. 6B, the parameter values extracted at the threshold value are classified. For example, for the brightness value, the maximum value 255 of 8-bit density value is assumed 1, the brightness value in the panel background is set at 0.5, and two values larger and smaller than 0.5 are provided, in which the brightness of detected pixel is V1 (“light”) for the larger value, or V2 (“dark”) for the smaller value. Likewise, the elongation degree and the thickness larger and smaller than the threshold values are denoted as S1 and S2, and F1 and F2, respectively. The image size of FIG. 6A represents the area a×b of the panel.

By this combination, there are eight upper-level classifications of the panel MURA, such as
[V1S1F1] . . . Light large MURA
[V1S1F2] . . . Light linear MURA
[V2S2F2] . . . Light dot MURA
[V1S2F2] . . . Light facial MURA
[V2S1F1] . . . Dark large MURA
[V2S1F2] . . . Dark linear MURA
[V2S2F1] . . . Dark dot MURA
[V2S2F2] . . . Dark facial MURA

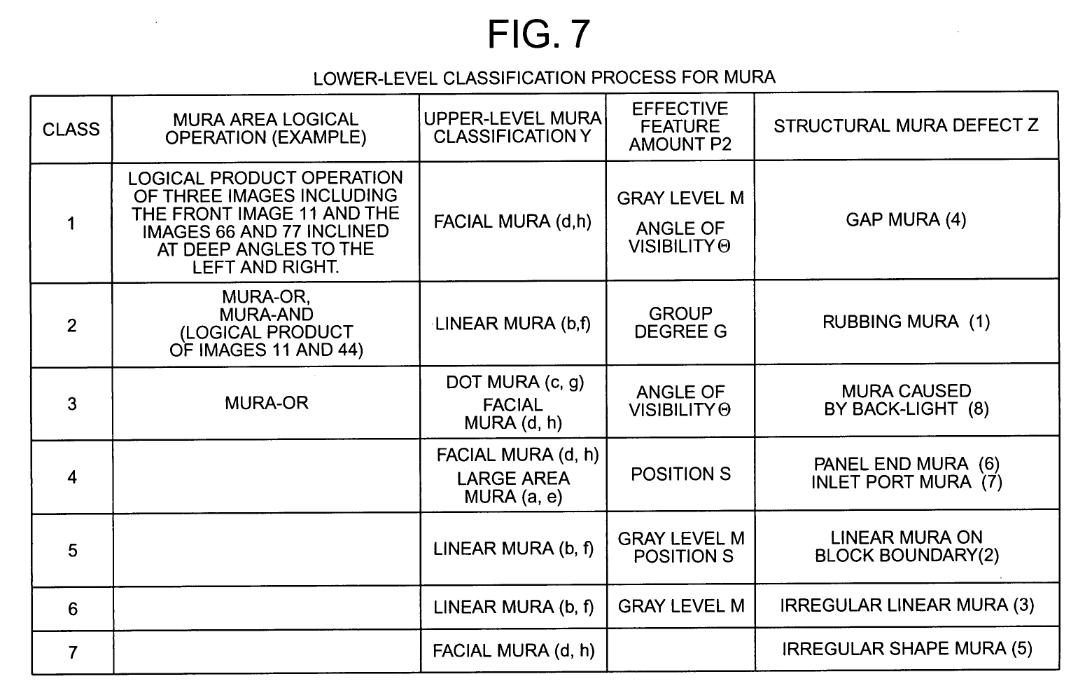

The MURA lower-level classification process (step S7) will be explained. For the MURA_OR area and MURA_AND area obtained through the MURA area logical operation process (step S5) or the detection area (output of path R) for which the MURA area logical operation is omitted, the MURA forms are classified (Z) by combining the upper-level classification according to the brightness and shape with the parameters that are the feature amounts P2 such as gray level M, position S, group degree G and angle of visibility Θ for that area, whereby the MURA arising on the surface of the liquid crystal display panel is classified and output as the panel MURA caused by the structure. FIG. 7 shows an example of the MURA classification and identification process according to this invention.

The gray level M represents a density difference between the MURA area and its peripheral area. The position S represents an occurrence position of the MURA area on the image. In the process, the whole image is segmented into plural areas, and the group degree G represents a proportion that plural MURA areas of the same kind exist within the segmented area. The angle of visibility Θ is a parameter representing the angle to effectively detect the photographed image. The operation for calculating the brightness V and the gray level M may be made for the image subject to MURA detection in the MURA_OR area, and the whole image in the MURA_AND area. Other feature amounts than the brightness V and the gray level M may be employed, if the indexes indicate the features effective for identifying the structural MURA.

The MURA area logical operation (example) of FIG. 7 is an example of the MURA area logical operation based on the apparent feature of typical MURA on the liquid crystal display panel of FIG. 2 to detect the MURA area containing the structural MURA. The column “classification” in FIG. 7 is the number of MURA lower-level classification, in which the structural MURA defects (1) to (8) are classified according to the combination of the MURA area logical operation X, the upper-level MURA classification Y and the effective feature amount P2. In the first column “MURA area logical operation”, it is shown that the logical operation for detecting the gap MURA (4) can be performed by the logical product of three images 11, 66 and 77. Apart from this logical operation expression, to detect the gap MURA (4), the gap MURA (4) can be detected by the logical operation for the logical product of three images 11, 44 and 88, or three images 11, 66 and 77. A certain kind of gap MURA looks whitish and blunt as seen from the front face, or may look blackish if seen inclined. From this, in some cases, the logical product of whitish or white defect and blackish or black detect may be employed to perform the MURA area logical operation. The MURA area of panel MURAs (2), (3), (5) to (7) can be detected only by the front image 1, as shown in FIG. 2, whereby the MURA area logical operation can be omitted (as indicated by the blank in the fourth to seventh columns of FIG. 7).

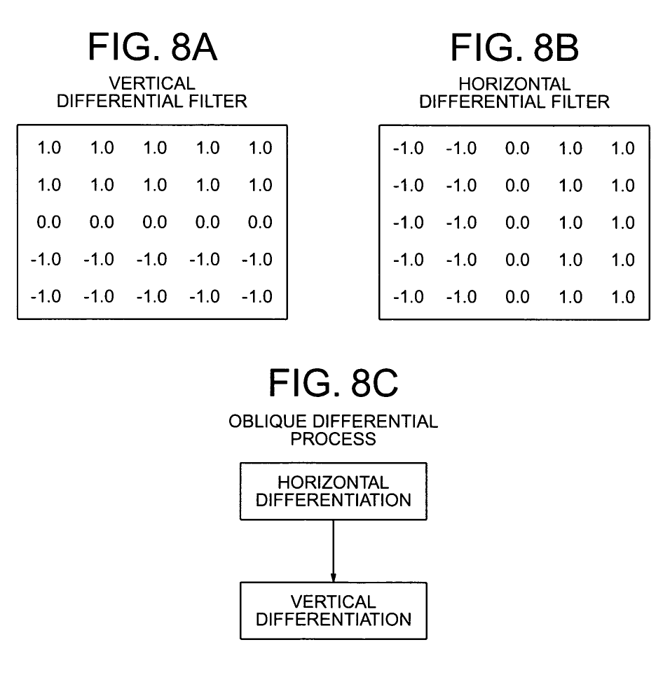

In the MURA area detecting process, the spatial differential filter process or the texture analysis process are employed. The spatial differential filter process may be a horizontal differential filter for performing the operation of FIG. 8B, a vertical differential filter for performing the operation of FIG. 8A, or an oblique differential process using both the horizontal differential filter and the vertical differential filter as shown in FIG. 8C. Thereby, the linear MURA where the density value of pixel is greatly changed and the MURA boundary can be detected. In the operation through the horizontal differential filter of FIG. 8B and the vertical differential filter of FIG. 8A, the densities of pixel points in a 5×5 area of pixels in a neighboring area around a pixel point of notice are multiplied by the weight in FIG. 8, and added to the density of the pixel point of notice, whereby a change in density in the horizontal and vertical directions near the pixel point of notice is detected.

The texture analysis process involves detecting the contrast in a local area of image using a density induced matrix obtained from the pixel density in an excited matrix area near the pixel point of notice, in which the area with high contrast value is detected as MURA.

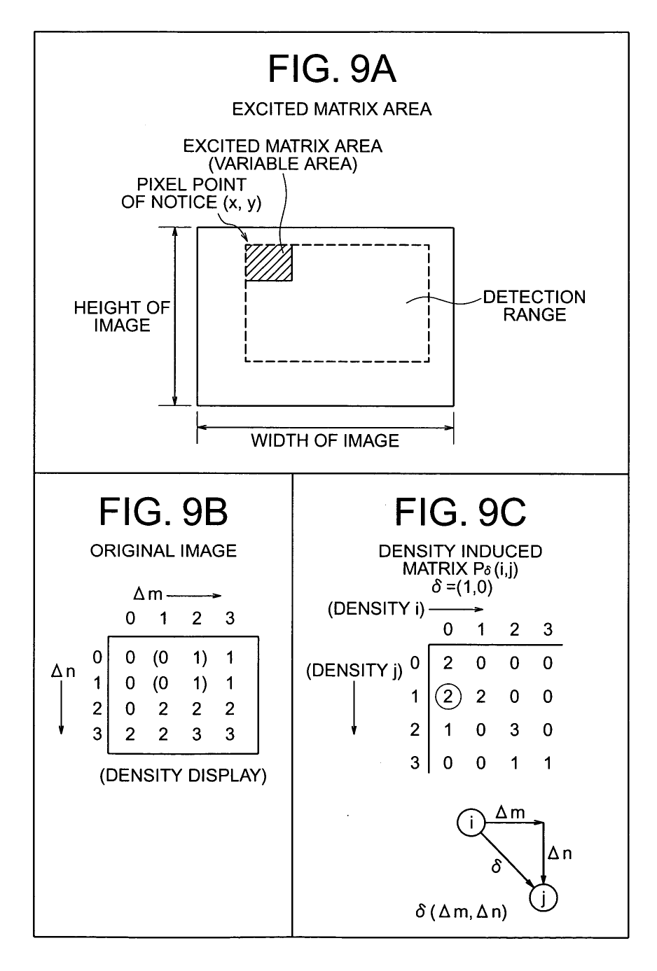

The hatching area of FIG. 9 indicates the excited matrix area (variable area—namely, the excited matrix area of FIG. 9 is variable because the excited matrix area is shifted) that is an operation area in the detected image. The pixel at the left upper corner in the excited matrix area is the pixel of notice (x, y). FIG. 9B shows one example of density value at the pixel point of original image in the excited matrix range (4×4 pixels) as numerical values 0, 1, 2, . . . . The parentheses ( ) in FIG. 9B will be described later. Δm is a horizontal value in a unit of pixel distance when the position of pixel point of notice (x, y) is 0, and Δn is a vertical value in a unit of pixel distance when the position of pixel point of notice (x, y) is 0.

The density induced matrix is the matrix composed of frequency Pδ(i, j) that the density at the pixel point (x+Δm, y+Δn) of displacement δ=(Δm, Δn) away from point (x, y) is j(x+Δm, y+Δn) when the density at the pixel point (x, y) within the area is i(x, y).

For the image in the excited matrix area of FIG. 9B, acquiring the frequency Pδ(i, j) of density change at a horizontal displacement of 1, namely, δ=(1,0), the density induced matrix is represented as in FIG. 9C. In this excited matrix area, the frequency Pδ(0,1) that the density value becomes from 0 to 1 is indicated by 2 encircled in FIG. 9C, and corresponds to the frequency of density change at two pixel points as indicated with ( ) in FIG. 9B.

Then, each element in the density induced matrix is normalized by the sum of all elements 2+2+2+1+3+1+1. Using the normalized elements, the contrast feature amount is computed. The computation for the contrast feature amount is given by the following expression (1). The expression (1) represents the mean of density difference between pair of pixels over the entire image in the local area corresponding to the operation area of the excited matrix, in which as there are more pairs of pixels with high density difference, the contrast value is increased. (Pδ(i, j) in the expression (1) is a normalized element, and the contrast value indicates the greater value as there is a greater deviation in the density pattern distribution between the excited matrix area and the area a predetermined distance away from the excited matrix area).

$$Contrast {\sum }_{i = 1}^{N} {\sum }_{j = 1}^{N} {( i - j )}^{2} \cdot {P}_{δ} ( i , j ) \qquad ( 1 )$$

The detection process of linear MURA through the spatial differential filter and the contrast detecting process with the density excited matrix are one method for detecting the MURA area, but are not limited. Any edge detecting or area detecting method may be applicable.

### EXAMPLE 2

In the example of FIG. 4, the MURA detection classification process is implemented on the personal computer or workstation using a software program. In this example, the process (steps S10, S30 to S40, S11, S21 to S41, . . .) for the MURA area detection in the processing algorithm is easily provided by hardware. This MURA area detecting process is performed in parallel and fast by employing DSP (Digital Signal Processor) or a programmable gate array such as FPGA (Field Programmable Gate Array).

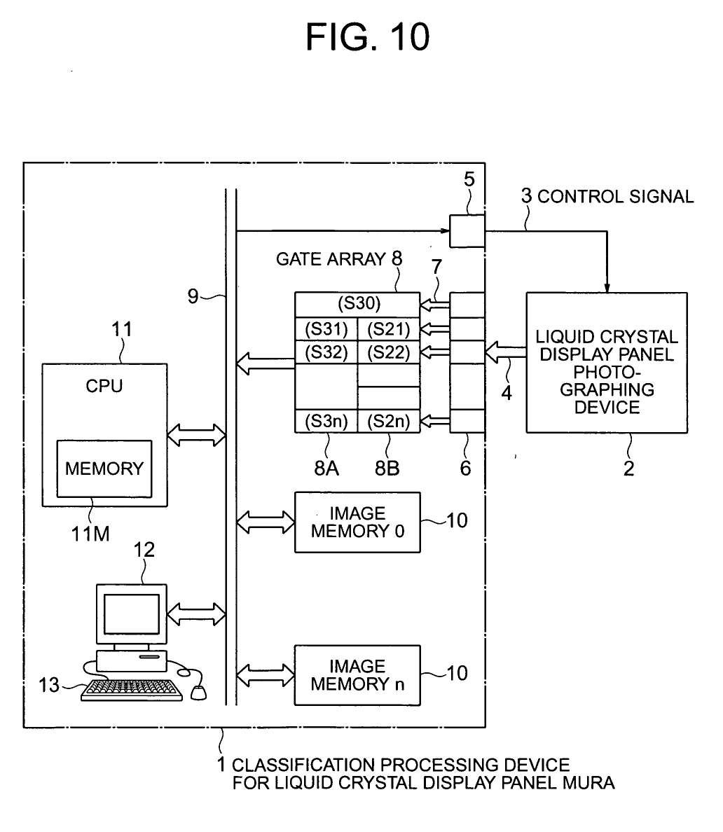

FIG. 10 is a concept view showing a classification processing device for the liquid crystal display panel MURA in which the programmable gate array is used for the MURA detecting process of the invention. In FIG. 10, 1 denotes a classification processing device for the liquid crystal display panel MURA that is constituted of a computer, 2 denotes a liquid crystal display panel photographing device, 3 denotes a control signal from the classification processing device 1 for the panel MURA, and 4 denotes an image signal of a liquid crystal panel face photographed by an image sensor. The control signal 3 serves to turn on a back-light of the liquid crystal panel, drive a table with the liquid crystal display panel mounted in a predetermined direction at a predetermined angle in a predetermined order, photograph the panel by the image sensor when the liquid crystal display panel is located in the predetermined direction at the predetermined angle (e.g., position of FIG. 3), and successively output an image signal to the classification processing device 1 for the liquid crystal display panel MURA.

Moreover, in FIG. 10, 5 denotes an output memory, 6 denotes an input memory for taking an image signal, 7 denotes a photographed image signal of the liquid crystal panel in predetermined direction at predetermined angle, 8 denotes a gate array, 8A denotes a gate array for making the logical operation of geometrical coordinate correcting process (steps S21 to S28 in FIG. 8), 8B denotes a gate array for making the logical operation of MURA area detecting process (steps S30 to S38 in FIG. 4), 9 denotes a bus, 10 denotes an image memory for recording an image signal for each photographed image, 11 denotes a CPU, 11M denotes a memory, 12 denotes a display unit, and 13 denotes an input unit.

The memory 11M stores a computer control program, a program for making the table driving, photographing control and image signal control for the liquid crystal display panel photographing device 2, and a classification processing program for classifying the panel MURA. The output image signal 4 of the liquid crystal display panel photographing device 2 is stored in the input memory 6 for each image. Each image signal 7 is input into the logical operation processing circuit (gate array) provided in parallel for each image of the gate array 8 to make the MURA area detecting process and the geometrical coordinate correction process and output a MURA area detected image signal. Each output MURA area detected image signal is stored in the corresponding image memory 10.

Based on the data stored in the image memory, the CPU 11 performs the MURA area logical operation process (step S5 in FIG. 4), the MURA upper-level classification process (step S6 in FIG. 4) and the MURA lower-level classification process (step S7 in FIG. 4) to classify and identify the liquid crystal panel MURA and display the result on the display unit 12. Using a keyboard and a mouse of the input unit 13, the control signal, the definition of parameters, threshold values, logical operation expressions, and images for use in the logical operation are set up.

Nowadays, when a personal computer is employed with the CPU of Pentium III and at a clock frequency of 700 MHz, one sheet of image data of one million pixels is processed, the processing time required for the MURA area detecting process (at the former stage in this invention) is about ten to twenty times longer than the processing time required for the MURA area logical operation process and the MURA lower-level classification process (at the latter stage in this invention). And the processing time of about one minute is required as a total of the former stage and the latter stage. If the programmable gate array such as DSP or FPGA is employed, the processing time is shortened to about 1/100 the processing time by software.

### EXAMPLE 3

Plural groups of images of the liquid crystal display panel photographed from different angles of visibility are taken in, and a program for performing the procedure of FIG. 4 to classify and identify the liquid crystal display panel MURA is created, and recorded on an information recording medium such as CD-ROM. For example, the program recorded on the information recording medium is read by a reader of the input unit 13 in the computer of FIG. 10, and installed or downloaded into the memory 11M to enable the computer to perform the processing procedure of FIG. 4.

### INDUSTRIAL APPLICABILITY

As described above, detection of a brightness MURA portion according to this invention is made using a group of image data taken from different angles or directions, namely, a group of image data polarized, to detect the MURA precisely, whereby the MURA caused by the structure of the liquid crystal display panel is classified. In the liquid crystal manufacturing field, this invention contributes to labor saving at final inspection step and at the same time leads to quality assurance and higher reliability of the liquid crystal panel.

1. A classification processing method for classifying the MURA on a liquid crystal display panel, characterized by comprising:
an image processing step of photographing said liquid crystal display panel from different angles of visibility, and detecting a MURA area for a group of images taken, using at least one of a texture analysis process and a spatial differential filter process;
a MURA area logical operation step of performing an image logical operation process between the group of images with MURA acquired at said image processing step;
a MURA upper-level classification step of classifying the shape of a MURA detected area acquired at said MURA area logical operation step by combining the parameters representing the shape of area and the brightness; and
a MURA lower-level classification step of classifying the MURA on the liquid crystal display panel by combining a classification for each MURA detected area acquired at said MURA upper-level classification step and the parameters representing the MURA distribution state, detected angle of visibility and position.

2. A classification processing device for classifying the MURA on a liquid crystal display panel, characterized in that the device comprises:
input means for photographing said liquid crystal display panel from different angles of visibility, and inputting a photographed image;
image processing means for taking in said photographed image and detecting a MURA area, using at least one of a texture analysis process and a spatial differential filter process;
MURA area logical operation processing means for performing an image logical operation process between a group of images with MURA area to detect the MURA area;
MURA upper-level classification processing means for classifying the shape of said MURA detected area by combining the parameters representing the shape of area and the brightness; and
MURA lower-level classification processing means for classifying the MURA on the liquid crystal display panel by combining a classification for each MURA detected area acquired by said MURA upper-level classification processing means and the parameters representing the MURA distribution state, detected angle of visibility and position, and
each means is implemented as electronic hardware.

3. A computer readable program for enabling a computer to perform a classification processing for classifying the MURA on a liquid crystal display panel, and said program comprises:
an image processing procedure of photographing said liquid crystal display panel from different angles of visibility, and detecting a MURA area for a group of images taken by said photographing, using of image processing techniques;
a MURA area logical operation processing procedure of performing an image logical operation process between the group of images with MURA area to detect a MURA detected area;
a MURA upper-level classification processing procedure of classifying the shape of the MURA detected area by combining the parameters representing the shape of area and the brightness; and
a MURA lower-level classification processing procedure of classifying the MURA on the liquid crystal display panel by combining a classification for each MURA detected area acquired through said MURA upper-level classification processing procedure and the parameters representing the MURA distribution state, detected angle of visibility and position.
